(19) United States
(12) Patent Application Publication
(10) Pub. No.: US 2003/0226913 A1
(43) Pub. Date: Dec. 11, 2003

(54) Emitter with pressure compensating fluid control valve

(75) Inventors: Steven P. Brunnengraeber, Clovis, CA (US); Edward H. Newbegin, Portland, OR (US)

Correspondence Address: Kolisch, Hartwell, Dickinson,, McCormack & Heuser, 200 Pacific Building, 520 S.W. Yamhill Street, Portland, OR, 97204, US

(73) Assignee: R.M. Wade & Co.

(21) Appl. No.: 10/170,066

(22) Filed: Jun. 11, 2002

(51) Int. Cl. B05B 15/00

(52) U.S. Cl. 239/542

(57) ABSTRACT

The present invention provides an in-line fluid emitter facilitating a controlled flow of fluid from a pipe in which the emitter is disposed. The emitter includes the following features: (1) a hollow generally cylindrical emitter body, with a plurality of openings defined in the emitter body to facilitate the flow of fluid therethrough; (2) a pressure compensating, resilient valve mounted in the emitter body; (3) a first passage defined in the emitter body directing the fluid from the openings to the valve; (4) an exit flow region defined in the emitter body, the exit flow region being in fluid connection with the output of the valve to receive fluid that has passed through the valve; and (5) a pair of annular sealing rings, one of which is disposed to a distal side of the openings, and the other of which is disposed to a distal side of the exit flow region, to seal the area between the pipe and the emitter.

### FIELD OF THE INVENTION

This invention relates to in-line fluid distribution emitters.

### BACKGROUND OF THE INVENTION

Drip and flow-rate controlled leaching systems have various applications in the mining industry. Similarly, drip and flow-rate controlled irrigation systems have a variety of uses in the agriculture and landscape industries. For each situation, it is desirable to control the amount of fluid, such as leaching agents or water, that flows through such a system over a given period of time. Various flow-rate control systems will achieve this result to varying degrees of success, but many such systems do not produce a constant flow rate over a range of system pressures. One example of such a system is an in-line emitter. Furthermore, in-line emitters are sometimes prone to clogging due to contaminates carried by the fluid through the relatively small channels of the emitter.

As a mechanism for controlling flow, currently developed emitters diminish fluid flow rate and pressure by means of hydraulic friction. Fluid is moved through a labyrinth of channels molded into the emitter exterior surface. Hydraulic friction through these channels reduces fluid pressure and flow rate, thereby providing a modicum of control over the rate of fluid distribution. While this method reduces flow rate, it does not provide a stable rate over a wide range of input-flow pressures. Furthermore, these emitters often do not provide identical flow rates between emitters throughout the distribution system. Such systems typically provide an attenuated discharge of varying rate proportional to system pressure. Alternative in-line flow-rate control devices are needed to produce exit-flow pressures, and therefore exit-flow rates, of relatively constant value.

Historically, in-line flow-rate emitters have been susceptible to plugging due to many factors, such as the presence of a variety of particulates in the fluid being distributed. This can be caused by precipitation of leaching chemicals, scale build up due to water hardness and added chemical treatments, introduction of carbon used in treatment processes and the entry of dirt and other debris as a result of drip lines being dragged across a mining site. Particulates may also result from sediment in the irrigation water source or contamination of the irrigation water source. Typically, emitters designed to achieve lower flow-rates are more susceptible to such plugging. The lower the pressure, the lower the flow-rate will be, and the more susceptible the system will be to plugging because of reduced system energy. Plugging can also occur as a result of pressure fluctuations and changes in elevation. Alternative flow-rate control devices are needed to minimize the likelihood of emitter plugging.

An elastomeric valve has been developed to control flow rates in fluid distribution systems. This technology is demonstrated in U.S. Pat. Nos. 4,846,406, 4,869,432 and 4,909,441. A valve frequently made of an elastomeric material such as silicon rubber is designed to modulate fluid flow in response to variations in fluid pressure in the system pipeline. As system pressure increases, the elastomeric valve closes to reduce flow rate. Conversely, the valve opens in response to a reduction in system pressure. This latter tendency also makes these valves well suited for purging contaminates that might otherwise plug an exit orifice. While the elastomeric valve has been used in fluid distribution systems, such valves have not been integrated with the in-line type emitter. This is because in-line emitters and pressure compensating flow controls have conventionally been viewed as two very different systems. Flow controls with elastomeric pressure compensating valves typically incorporate the elastomeric valve in a position such that an entire in-line flow passes through the pressure compensating valve. Until now, no one has thought to combine the advantages of a pressure compensating valve with an in-line emitter in which the flow is a peripheral flow between the emitter and the tubing or pipe in which it is disposed.

### SUMMARY OF THE INVENTION

The present invention provides an in-line fluid emitter facilitating a controlled flow of fluid from a pipe in which the emitter is disposed, comprising (1) a hollow generally cylindrical emitter body, with a plurality of openings defined in the emitter body to facilitate the flow of fluid therethrough; (2) a pressure compensating, resilient valve mounted in the emitter body; (3) a first passage defined in the emitter body directing the fluid from the openings to the valve; (4) an exit flow region defined in the emitter body, the exit flow region being in fluid connection with the output of the valve to receive fluid that has passed through the valve; and (5) a pair of annular sealing rings, one of which is disposed to a distal side of the openings, and the other of which is disposed to a distal side of the exit flow region, to seal the area between the pipe and the emitter.

Another aspect of the invention is a method for providing a flow of fluid from a pipe that compensates for variations in input pressure. The method includes the following steps: (1) providing a fluid emitter having a hollow, generally cylindrical emitter body, a plurality of openings defined in the emitter body to facilitate the flow of fluid therethrough, and an exit flow region; (2) positioning a pressure compensating, resilient valve in the emitter body, downstream of the openings and upstream of the exit flow region, and in fluid communication with both; and (3) creating an orifice in the pipe in fluid communication with the exit flow region to permit fluid to flow from the emitter out of the pipe.

Yet another aspect of the present invention is an in-line fluid emitter facilitating a controlled flow of fluid from a pipe in which the emitter is disposed. The emitter includes the following features: (1) a hollow generally cylindrical emitter body; (2) channels for directed fluid flow on the exterior surface of the body, hydraulically coupled with the hollow interior of the body; (3) a pressure compensating, resilient valve mounted to the emitter body such that fluid that passes through the channels flows through the valve; and (4) raised annular sealing rings positioned on the emitter disposed distally of the channels and valve such that they generally seal the area between the emitter and a pipe.

### BRIEF DESCRIPTION OF THE DRAWINGS

FIG. 1 is a schematic side elevation view of a pipe having a plurality of in-line emitters therein;

FIG. 2 is an isometric exploded view of one of the in-line emitters of FIG. 1;

FIG. 3 is another isometric view of one of the in-line emitters of FIG. 1;

FIG. 4 is yet another isometric view of one of the in-line emitters of FIG. 1;

FIG. 5 is a side elevation view of the embodiment of one of the in-line emitters of FIG. 1, showing the back side of the emitter;

FIG. 6 is an enlarged isometric view of the pressure compensating valve of one of the emitters of FIG. 1;

FIG. 7 is another enlarged isometric view of the pressure compensating valve of one of the emitters of FIG. 1;

FIG. 8 is an isometric view of one of the in-line emitters of FIG. 1, showing the pressure compensating valve and its housing in place in the emitter body; and

FIG. 9 is a side elevation sectional view of one of the emitter of FIG. 1, showing the flow of fluid through the valve.

### DETAILED DESCRIPTION OF THE PREFERRED EMBODIMENTS

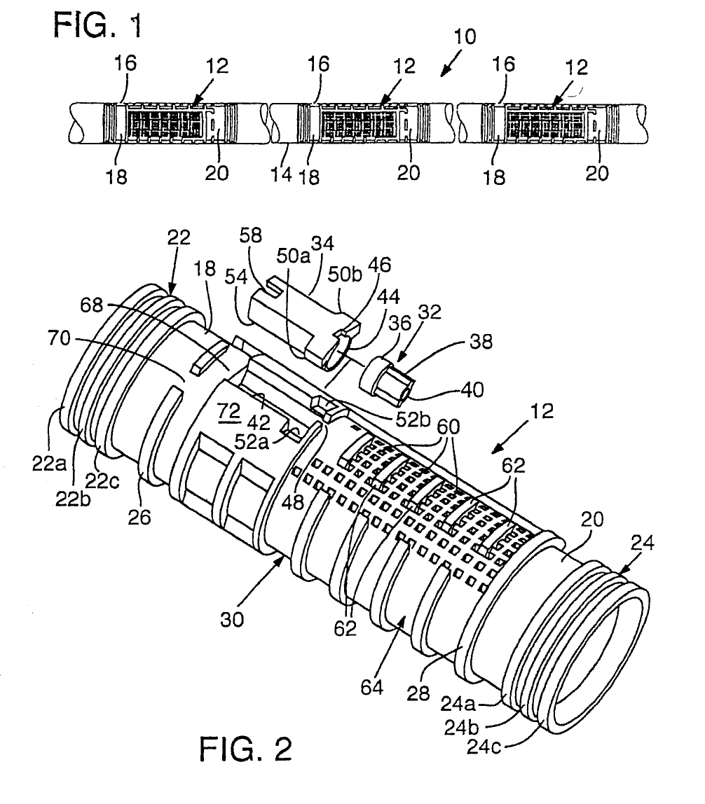

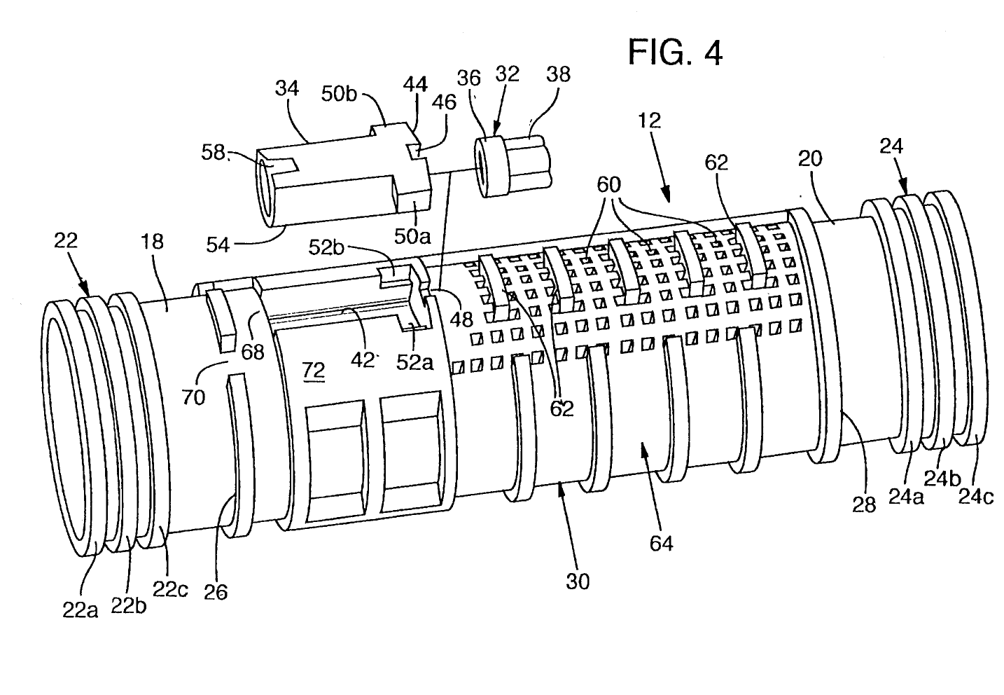

FIGS. 1-9 depict a preferred embodiment of the present invention. FIG. 1 is a schematic drawing illustrating a portion of a simplified fluid distribution system 10. The system depicted includes plural in-line emitters 12 positioned within a pipe 14, with orifices 16. Pipe orifices 16 are disposed in axial alignment with exit flow regions 18 or 20 in emitters 12. It can be seen that regions 18 and 20 are defined at their axially-outer or distal sides by annular sealing rings 22 and 24, respectively. As will be explained more fully below, sealing rings 22 and 24 seal the area between emitter 12 and the inner surface of pipe 14. Annular ridges 26 and 28 define the axially-inner sides of regions 18 and 20, respectively. As will be explained in detail below and as depicted in FIGS. 2-5, annular ridges 26 and 28 do not extend around the entire periphery of emitter 12 in order to facilitate flow of fluid into exit flow regions 18 and 20. The gap(s) in annular ridges 26 and 28 have not been shown in FIG. 1 for simplification but will be shown and discussed below.

Emitter 12 is comprised of essentially three parts: an emitter body 30; a pressure compensating valve 32; and a valve housing 34. As shown in the figures, valve 32 fits into housing 34, which mounts to emitter body 30. The construction of valve 32 and housing 34 and the relationship between these components will first be described before turning to the emitter body itself.

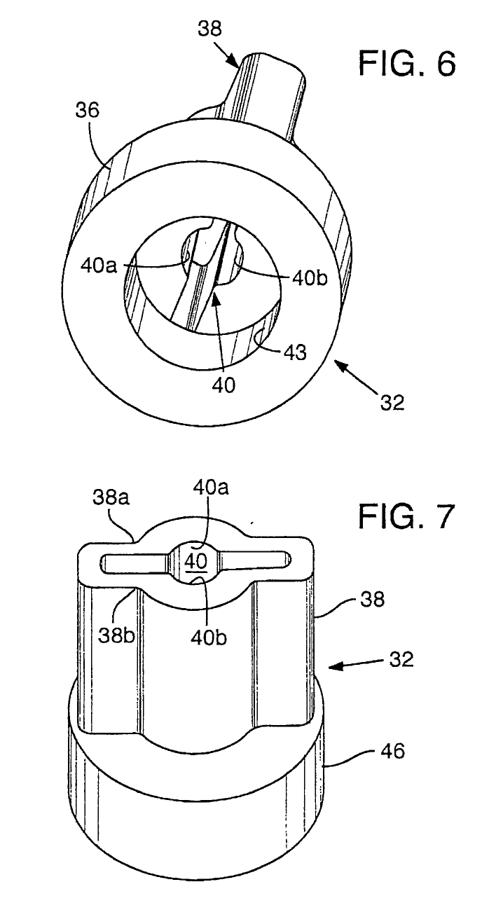

Pressure compensating valve 32 is best shown in FIGS. 6 and 7. The valve includes two components—a mounting shoulder 36 and a flapper valve 38. Flapper valve 38 is comprised of two identical flap portions 38a and 38b formed to extend in a generally parallel fashion, close to each other. Flap portions 38a and 38b are formed of a resilient material, preferably silicon rubber. Each flap includes a semicylindrical groove 40a or 40b, which combine to form a generally cylindrical channel 40 extending entirely through flapper valve 38. As will be explained more fully below, the presence of channel 40 ensures a certain predetermined amount of flow through valve 32 even when flap portions 38a and b are closed tightly against one another.

Flap portions 38a and b of flapper valve 38 are mounted by adhesive or other permanent means to mounting shoulder 36. Both mounting shoulder 36 and flapper valve 38 are designed to fit within a cylindrical space defined in valve housing 34.

The cylindrical shape of mounting shoulder 36 has a diameter slightly greater than the side-to-side dimension of flapper valve 38. Mounting shoulder 36 has an inner diameter 43 (see FIG. 6) that is somewhat larger than the diameter of flapper valve 38 when it is entirely open.

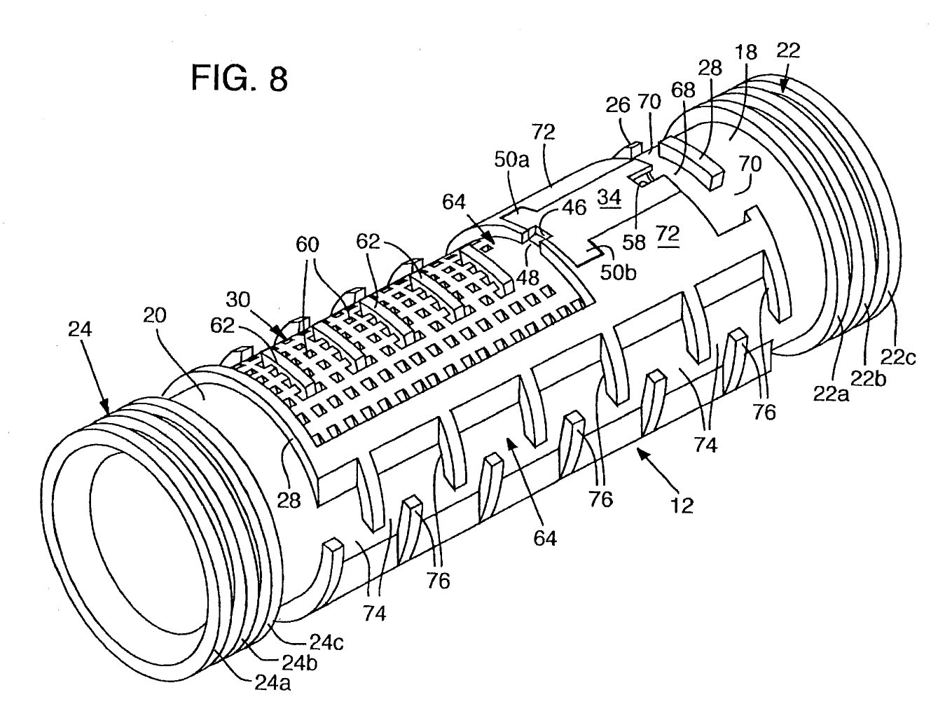

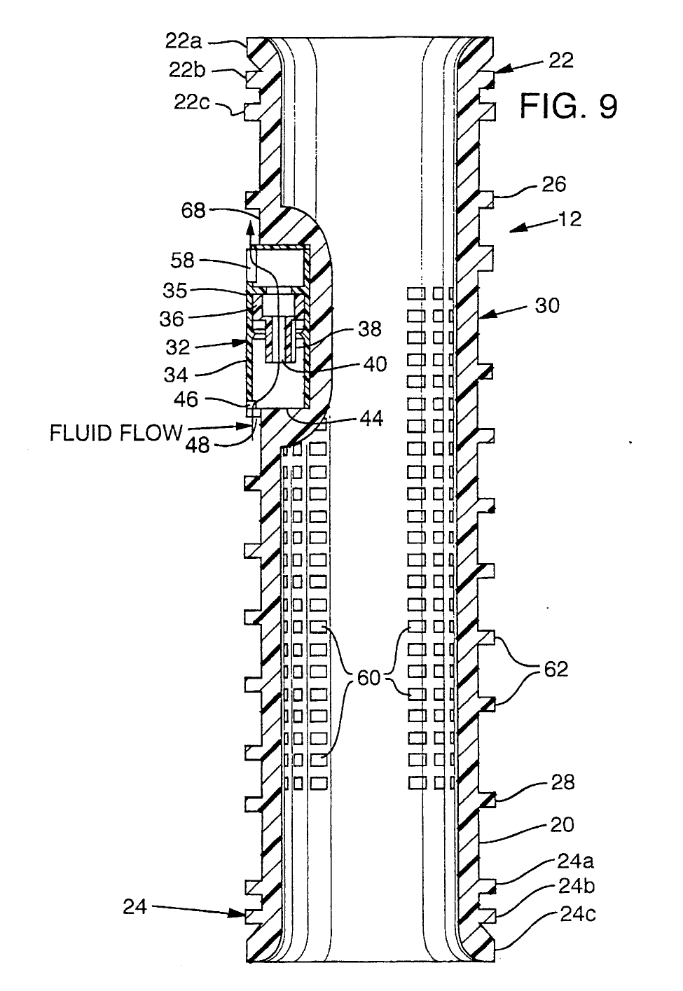

FIG. 9 shows valve 32 positioned within valve housing 34. It can be seen that flapper valve 38 is positioned well inside of housing 34. Precise positioning of valve 32 is possible because mounting shoulder 36 is fitted against a complementing wall 35 in housing 34. Peripheral edge 44 includes a notch 46 at the upper or outer portion designed to complement a corresponding notch 48 in emitter body 30, as shown best in FIG. 8. Complementing notches 46 and 48 are designed to facilitate flow of fluid into valve housing 34 and then through valve 32 as shown in FIG. 9 and as will be explained more fully as this discussion continues.

Valve housing 34 includes a pair of mounting wings 50a and 50b that fit into a corresponding pair of undercut portions 52a and 52b in emitter body 30. The upper or exterior profile of wings 50a and b is rounded to conform to the inner diameter of pipe 14 within which emitter 12 is designed to fit. The remaining portion of valve housing 34 is also profiled to fit within the cylindrical inner diameter of pipe 14.

The underside or inner side 54 of valve housing 34 is typically cylindrical, as is a complementing cylindrical space 42 of emitter body 30. The end of valve housing 34 that is opposite from valve 32 is provided with a fluid exit notch 58 to permit fluid that has passed through valve 32 to exit the valve housing. Valve housing 34 with valve 32 mounted therein can typically merely be press-fit into the complementing cylindrical space 42 in emitter body 30, although in certain applications it may be desirable to actually snap the housing in place, using one or more detent ridges (not shown). The remaining portion of emitter body 30 will now be described. The order that this description will follow will conform to the passage of fluid through the system 10. As noted previously, in-line emitter 12 is positioned within pipe 14. The fit is tight, so that annular sealing rings 22 and 24 fit tightly against the inner diameter of pipe 14. As depicted, annular sealing ring 22 is disposed distally of exit flow region 18 while annular sealing ring 24 is disposed distally of openings 60 to be described below. Annular sealing rings 22 and 24 are actually made up of separate rings 22a, b and c and 24a, b and c. This provides three separate seals that best insures that there will be minimal leakage across the seal.

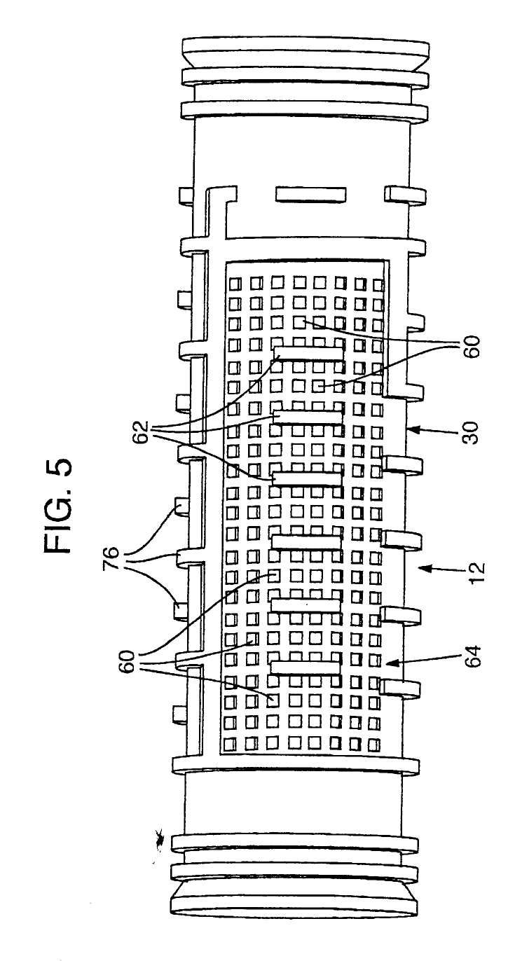

The inner periphery of emitter body 30 is typically smooth, to minimize any disruption and flow of fluid through pipe 14. That fluid which does pass through emitter 12 first passes through openings 60 in emitter body 30. There are normally several hundred such openings, although the number and size of such openings may be varied depending on the particular application. A typical size would be approximately 1/64 of an inch square. Another way to describe these openings is that collectively they define a screen. As shown in the figures, these openings 60 cover much of the surface of emitter body 30, although in the preferred embodiment the openings are in two arrays, offset 180° from each other. One such array is shown in FIGS. 2-4 and the other is shown in FIG. 5. A plurality of circumferentially extending support ridges 62 extend between openings 60 to support pipe 14 and maintain the spacing between the inner diameter of pipe 14 and an outer surface area 64 of emitter body 30. The fluid that has flowed through openings 60 is prevented from passing directly into exit flow region 20 by annular ridge 28. Therefore, the only place for the fluid to go is to pass through pressure compensating valve 32.

Depending upon the fluid pressure, flap portions 38a and b of flapper valve 38 will be in their closed position with the flap portions 38a and b tight against each other to minimize flow during periods of high inlet pressure, or in a full open position in which flap portions 38a and b yawn open to maximize flow during periods of low pressure, or any position therebetween. An intermediate position is shown in FIGS. 6 and 7. In their closed position, the only opening in valve 32 is defined by a central channel 40 extending through flapper 38. This ensures that even when the valve is closed, there will be some flow of fluid through the valve. Because the opening in valve 32 is small when pressure is at its highest, this will even-out the ultimate flow from the emitter during periods of peak pressure. When lower pressure is present, there will be less pressure on flap portions 38a and b, so the flaps will take a more open position. During these periods of low pressure, flow will be maximized to again even-out the flow regardless of the inlet pressure. Once fluid passes through flapper valve 38 and the interior of valve housing 34, it passes out fluid exit notch 58 and through the rear of the housing to enter valve exit region 68 where the fluid is directed through gaps 70 and into exit flow region 18. Fluid then can pass through orifice 16 for irrigation or leaching purposes.

Adjacent to pressure compensating valve 32 and valve housing 34 is a pipe-supporting surface 72 which, like supporting ridges 62, supports pipe 14. It has been determined that the presence of this supporting surface 72 in combination with annular sealing rings 22 and 24, as well as support ridges 62, provides sufficient support that pipe 14 is unlikely to collapse even when confronted with substantial exterior loads such as may be encountered when pipe 14 is buried under several feet of minerals being leached.

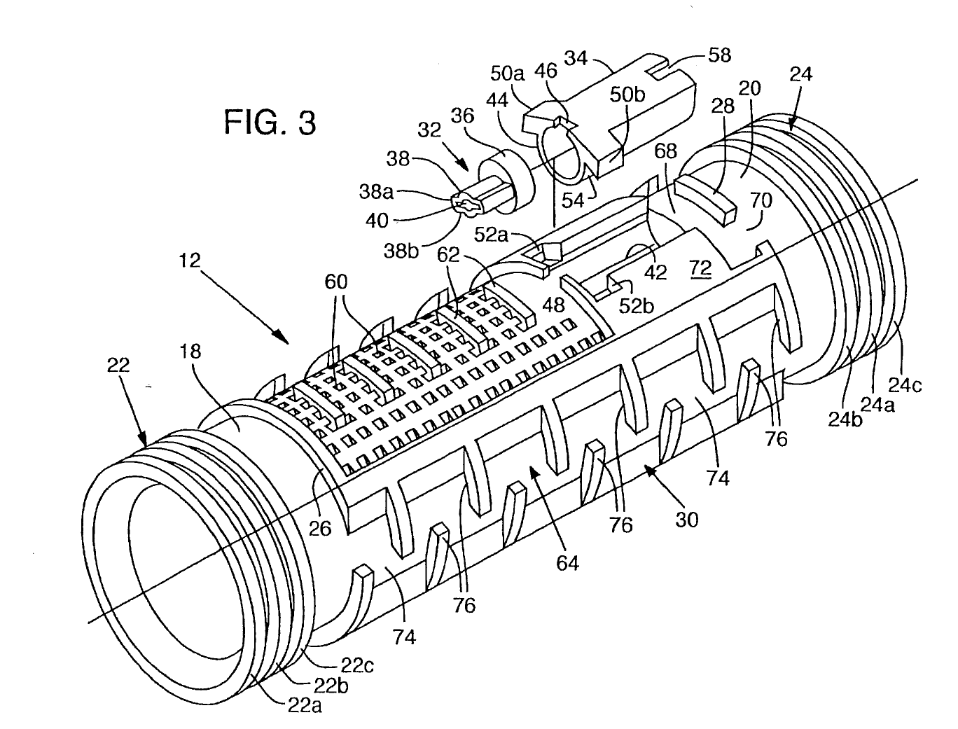

System 10 is used in many applications where clogging of orifices 16 may be possible. This problem is particularly acute in mining operations. In the event that any of orifices 16 become clogged, one advantage of the system is that a second orifice may be formed in pipe 14, but instead of being positioned in exit flow region 18, it may be bored into pipe 14 at exit flow region 20. Thus, if orifice 16 and its adjacent flow region 18 is clogged with particulate, fluid may pass through the region indicated at 74 in FIGS. 3 and 8 and thus access exit flow region 20. Given the configuration of region 74, there will be little pressure drop as fluid passes the length of emitter 12 and then out the new orifice. A plurality of support ridges 76 are provided in region 74 to support pipe 14 away from emitter body surface area 64. This ability of being able to bore or cut a second hole in emitter 12 means that this emitter can be kept functional without having to cut the pipe to remove a clogged emitter, and replace it with another.

Variation in the configuration of flapper valve 38 permits a 5-fold increase in the size of the emission path diameter. It has been found that a relatively constant discharge rate can be achieved through a range of input pressure between 10 and 60 psi. The depicted embodiment also facilitates a purging cycle which can be used to purge emitter 12 and its pressure compensating valve 32. An additional advantage of system 10 is that different pressure compensating valves 32 may be substituted one for the other, to provide an emitter which will have a greater or lesser flow rate. Valves having flow rates of ½, ¾, 2 and 3 gph are typically provided. Alternative pressure compensating valves may be color coded to show differences in flow rate.

These and other variations and modifications to the preferred embodiment may be made without departing from the spirit and scope of the present invention. These and other modifications within the scope of this disclosure are intended to be covered by the claims which follow.

I claim:

1. An in-line fluid emitter facilitating a controlled flow of fluid from a pipe in which the emitter is disposed, comprising:
a hollow generally cylindrical emitter body, with a plurality of openings defined in the emitter body to facilitate the flow of fluid therethrough;
a pressure compensating, resilient valve mounted in the emitter body;
a first passage defined in the emitter body directing the fluid from the openings to the valve;
an exit flow region defined in the emitter body, the exit flow region being in fluid connection with the output of the valve to receive fluid that has passed through the valve; and
a pair of annular sealing rings, one of which is disposed to a distal side of the openings, and the other of which is disposed to a distal side of the exit flow region, to seal the area between the pipe and the emitter.

2. The emitter of claim 1, further comprising at least one orifice in the pipe in fluid communication with the exit flow region to permit fluid to flow from the emitter out of the pipe.

3. The emitter of claim 1 wherein the valve includes a pair of flapper portions mounted adjacent one another with an axial channel defined therebetween.

4. The emitter of claim 1, further comprising a second exit flow region in fluid communication with the output of the valve.

5. The emitter of claim 1 wherein the valve is disposed in a valve housing which is mounted in the emitter body.

6. A method for providing a flow of fluid from a pipe that compensates for variations in input pressure, comprising:
providing a fluid emitter having a hollow, generally cylindrical emitter body, a plurality of openings defined in the emitter body to facilitate the flow of fluid therethrough, and an exit flow region;
positioning a pressure compensating, resilient valve in the emitter body, downstream of the openings and upstream of the exit flow region, and in fluid communication with both; and
creating an orifice in the pipe in fluid communication with the exit flow region to permit fluid to flow from the emitter out of the pipe.

7. The method of claim 6, further comprising providing a pair of annular sealing rings in the emitter body, one of which is disposed to a distal side of the openings, and the other of which is disposed to a distal side of the exit flow region to seal the area between the pipe and the emitter.

8. An in-line fluid emitter facilitating a controlled flow of fluid from a pipe in which the emitter is disposed, comprising:
a hollow generally cylindrical emitter body;
channels for directed fluid flow on the exterior surface of the body, hydraulically coupled with the hollow interior of the body;
a pressure compensating, resilient valve mounted to the emitter body such that fluid that passes through the channels flows through the valve; and
raised annular sealing rings positioned on the emitter disposed distally of the channels and valve such that they generally seal the area between the emitter and a pipe.
